(19) United States
(12) Patent Application Publication
(10) Pub. No.: US 2013/0144847 A1
(43) Pub. Date: Jun. 6, 2013

(54) De-Duplication of Featured Content

(71) Applicant: John Walker SPURLOCK, Boston, MA (US)

(72) Inventor: John Walker SPURLOCK, Boston, MA (US)

(73) Assignee: GOOGLE INC., Mountain View, CA (US)

(21) Appl. No.: 13/311,281

(22) Filed: Dec. 5, 2011

(51) Int. Cl. G06F 7/00

(52) U.S. Cl. 707/692; 707/E17.005; 707/E17.119

(57) ABSTRACT

A system, computer-implemented method and computer-readable medium for managing duplicate articles are provided. A first and a second potentially duplicate article of a magazine edition are accessed, the first article associated with a first title and a first URL and the second article associated with a second title and a second URL. The titles are normalized. The first normalized title is compared to the second normalized title and the first URL is compared to the second URL to determine whether the first article and the second article are duplicates. It is determined that the first article and the second article are duplicates when the first normalized title is considered similar to the second normalized title and the first URL is considered similar to the second URL. Otherwise, it is determined that the first article and the second article are not duplicates.

### BACKGROUND

1. Technical Field

The technical field is managing duplicate media content.

2. Background

Users gain access to media content via the Internet or the World Wide Web (or simply the “Web”) using websites. In one example, users enter a website address on their mobile devices to access media content. In another example, users may download an application provided by a particular content provider onto their mobile device. The application then presents a user with media content that is periodically uploaded to the application from a content source provided by the content provider.

However, as content sources accumulate content, there may be overlap between specific articles included by content sources. For example, multiple users may submit duplicate articles that are identical, or are so similar that providing both articles is unnecessary.

### BRIEF SUMMARY

A system, computer-implemented method and computer-readable medium for managing duplicate articles are provided. A first and a second article are identified. The first article is associated with a first title and a first URL. The second article is associated with a second title and a second URL. The first title is normalized to produce a first normalized title. The second title is normalized to produce a second normalized title. The first normalized title is compared to the second normalized title and the first URL is compared to the second URL to determine whether the first article and the second article are duplicates. It is determined that the first article and the second article are duplicates in response to determining the first normalized title is considered similar to the second normalized title and the first URL is considered similar to the second URL. In an embodiment, it is also determined that the first article and the second article are duplicates in response to determining the first URL is the same as the second URL. Otherwise, it is determined that the first article and the second article are not duplicates.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1A is a block diagram of a distributed system environment, according to an embodiment.

FIG. 1B is a block diagram of components in distributed system 100 that generate and distribute magazine editions, according to an embodiment.

FIG. 1C is a block diagram that describes an exemplary communication interfaces between the components within the distributed system, according to an embodiment.

FIG. 1D is a block diagram of an exemplary de-duplication manager.

FIG. 2A is a block diagram of an edition player, according to an embodiment.

FIG. 2B is a block diagram of a current module for displaying magazine editions, according to an embodiment.

FIG. 3 is a block diagram of an applications data model, according to an embodiment.

FIG. 4A is a block diagram of a studio architecture, according to an embodiment.

FIG. 4B is a screen shot of an exemplary embodiment of a studio displaying a user interface.

FIG. 5 is a flowchart of a method for managing duplicate articles, according to an embodiment.

FIG. 6 is a diagram of examples of duplicate articles that an embodiment might identify.

FIG. 7 is a flowchart of possible actions to take if duplicate articles are identified, according to an embodiment.

FIG. 8 is a block diagram of a computer system in which embodiments of the invention can be implemented.

Various embodiments of the invention are described below with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

The approaches to managing duplicate articles that are described herein operate in the context of a magazine edition. Hence, an exemplary version of a magazine edition for which duplicate articles may be managed will be discussed, in order to clarify a potential environment in which embodiments may operate. Aspects of managing duplicate articles will be discussed as features that may be incorporated into a magazine edition.

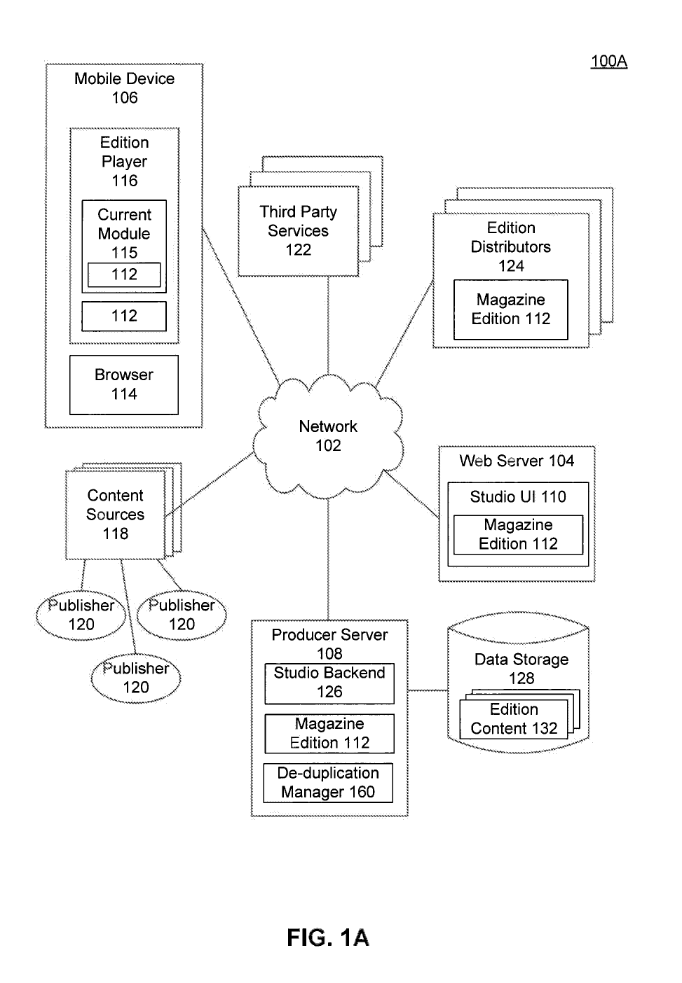

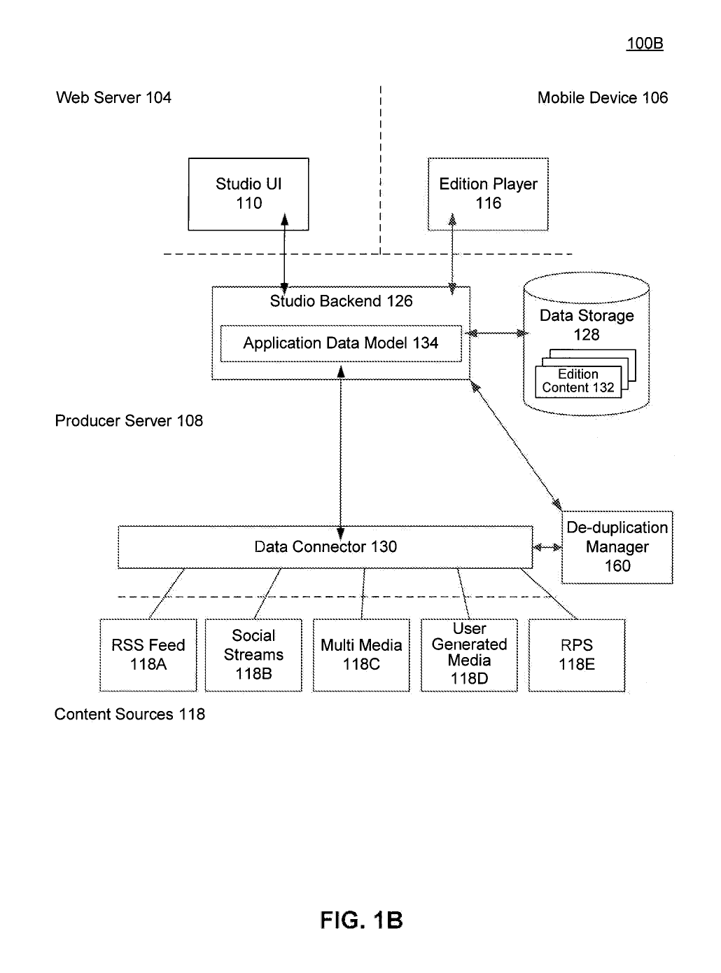

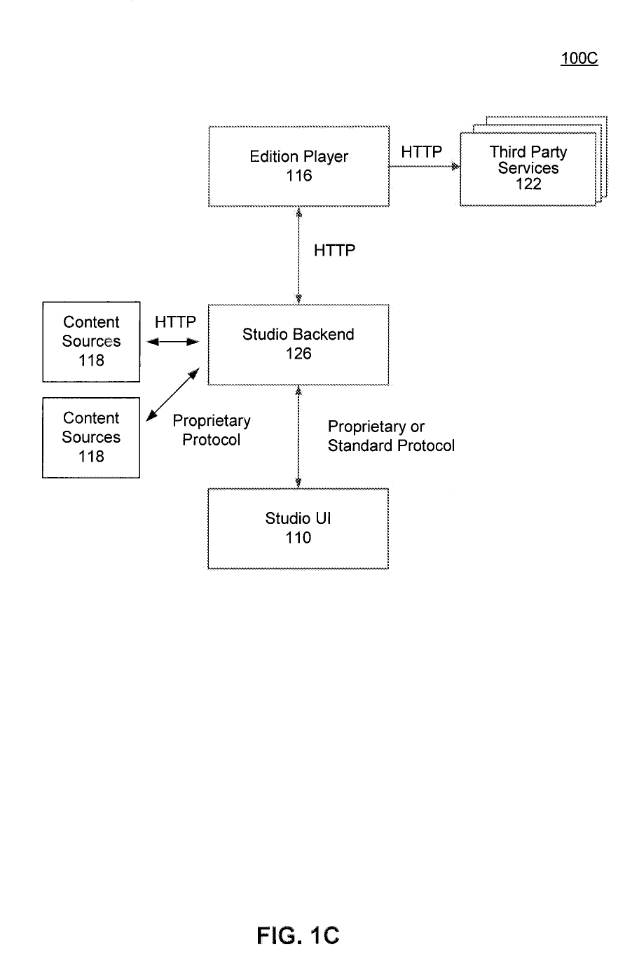

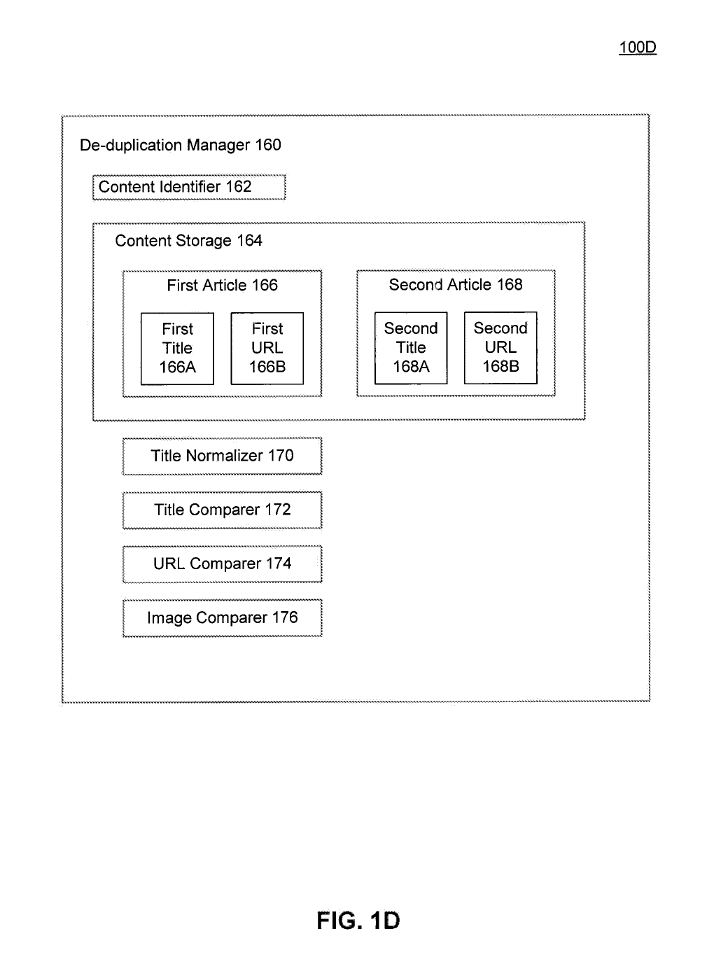

FIG. 1A is a block diagram 100A of a distributed system environment. Distributed system environment 100A includes one or more networks 102, web servers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106. Publisher 120 may access studio UI 110 using a web address that is hosted on web server 104. Once accessed, publisher 120 may use studio UI 110 to design the layout of magazine edition 112 and configure content sources 118 for mobile devices 106 having different specifications.

In another embodiment, publisher 120 may download studio UI 110 onto a mobile device 106 as a standalone application or as a plugin or extension to a browser.

Magazine edition 112 may be designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also layout edition content according to the size of a display screen of mobile device 106.

However, it may be noted that as publishers 120 create content, it is possible that some of the content may be duplicative. Management of duplicate content occurs at de-duplication manager 160. The operation of de-duplication manager 160 is discussed in greater detail, below.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116. Before edition player 116 displays edition content, de-duplication manager 160 may act to manage duplicate content in magazine edition 112.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. As part of the update that occurs at current module 115, de-duplication manager 160 may act to manage duplicate content in magazine edition 112. In an embodiment, current module 115 also provides a user with a listing of recommended magazine editions 112 that may be of interest to the user and that a user may subscribe to.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112. Producer server 108 may additionally include de-duplication manager 160, which will manage de-duplication so as to eliminate redundancy within distributed system 100.

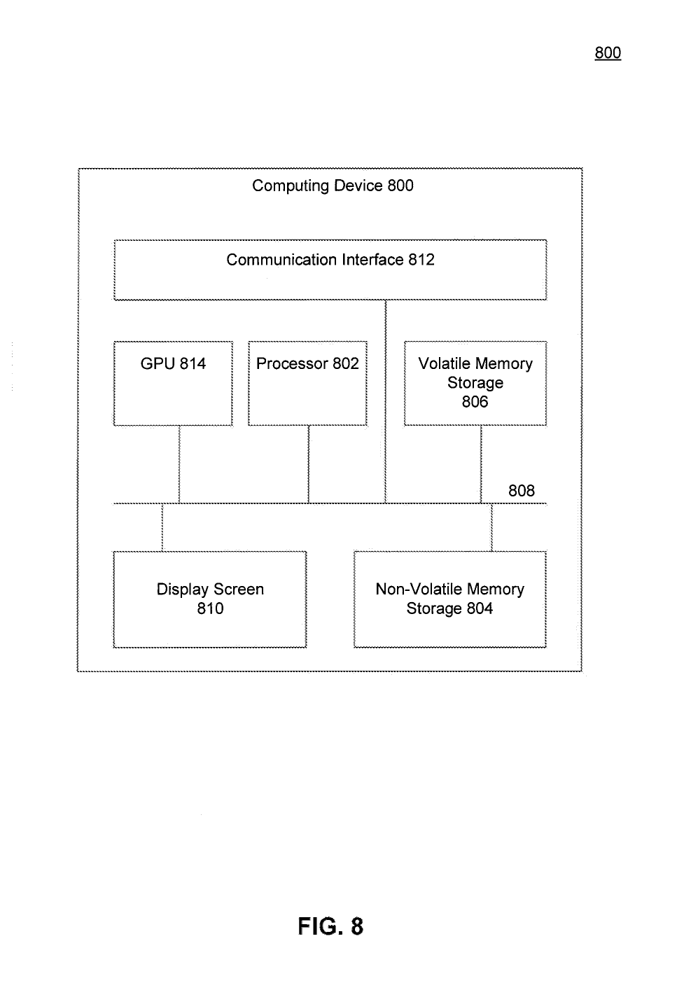

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 8. In another embodiment, publisher 120 may upload magazine edition 112 to edition distributors 124. A user may access edition distributor 124 and download magazine edition 112 to mobile device 106. In an embodiment, once publisher 120 decides to distribute an upgraded magazine edition 112, mobile devices 106 that include a previous version of magazine edition 112 are synchronized with the upgraded magazine edition 112. Synchronization may involve de-duplication, as performed by de-duplication manager 160.

Content sources 118 provide edition content 132 to magazine edition 112. Example content sources 118 include data feeds, RSS feeds, social streams, user-generated media sources, multi-media sources via media RSS, etc. Content source 118 is typically associated with a publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 8. In an embodiment, data storage 128 may include a database for storing edition content 132. When magazine edition 112 executing on edition player 116 requests edition content 132, producer server 108 retrieves edition content 132 is retrieved from data storage 128 and transmits edition content 132 to edition player 116. De-duplication may be performed by de-duplication manager 160 both when edition content 132 is stored, to avoid storing unnecessarily redundant information, or alternatively when edition content 132 is retrieved, to avoid providing edition content 132 that is redundant.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112, to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. A user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein, content sources 118 provide edition content 132 that is distributed across the web via network 102. For the edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 transmits edition content 132 to data storage 128.

However, data connector 130 is connected to de-duplication manager 160. As data connector 130 receives edition content 132 from content sources 118, de-duplication manager 160 processes the edition content 132 to ensure that duplicate content has been processed properly.

As described herein, data storage 128 distributes data from content sources 118 to magazine editions 112. For example, mobile device 106 may request data for particular magazine editions 112 at configurable time intervals that may be configured by the user subscribing to magazine editions 112. However, as noted, de-duplication manager 160 may preprocess data from content sources 118, such that potentially duplicate content in content sources 118 may be removed or otherwise responded to.

Studio backend 126 receives the designed magazine editions 112 from studio UI 110. As described herein, studio UI 110 allows publishers 120 to design dynamic and interactive magazine editions that display edition content 132 provided by their content sources 118. Once publisher 120 completes designing magazine edition 112, publisher 120 uploads magazine edition 112 to studio backend 126. Studio backend 126 then stores the uploaded magazine editions 112 on producer server 108 and/or distributes magazine editions 112 to mobile devices 106 or edition distributors 124. However, as noted, de-duplication manager 160 may preprocess data for studio backend 126, such that potentially duplicate content in magazine editions 112 may be removed or otherwise responded to.

Studio backend 126 includes application data model 134. Application data model 134 (described in detail below), includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 120 for presentation to a user.

Upon a user request from mobile device 106, studio backend 126 may distribute magazine editions 112 to mobile devices 106. Each magazine edition 112 includes application data model 134 that is configured by publisher 120.

Studio backend 126 is also connected to de-duplication manager 160. As studio backend 126 communicates with studio UI 110 and edition player 116, de-duplication manager 160 processes magazine edition 112 to ensure that duplicate content has been processed properly.

When magazine edition 112 is uploaded to mobile device 106, magazine edition 112 is populated with edition content 132. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102. As discussed, de-duplication manager 160 may participate in the synchronization process to ensure that duplicate content is processed properly.

FIG. 1C is a block diagram 100C that describes an exemplary communication interface between the components within the distributed system.

For example, edition player 116 may communicate with studio backend 126 using HTTP over network 102. Edition player 116 may also communicate to third party services 122 and edition distributors 124 using HTTP.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skill in that art, to pass data that includes magazine editions 112, templates, edition content 132, etc., between studio UI 110 and studio backend 126.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP. As studio backend 126 communicates with content sources 118, de-duplication manager 160 ensures that duplicate content is handled properly. While de-duplication manager 160 is not shown in FIG. 1C, it may be recognized from the representation of de-duplication manager 160 is FIGS. 1A-B that de-duplication manager 160 manages duplication between content sources 118 and studio backend 126, as well as between studio backend 126 and edition player 116 and studio UI 110.

FIG. 1D is a block diagram 100D of an exemplary de-duplication manager 160. De-duplication manager 160 is a constituent part of producer server 108. It interacts with data connector 130 and studio backend 126 as has been previously discussed. De-duplication manager 160 includes a variety of functional subsystems. These functional subsystems may include a content identifier 162, a content storage 164, a title normalizer 170, a title comparer 172, a URL comparer 174, and an image comparer 176. However, the specific subsystems included in de-duplication manager 160 may include other systems, and not all of these subsystems will necessarily be present in every embodiment. Additionally, content storage 164 may store a first article 166, associated with a first title 166A and a first URL 166B and a second article 168, associated with a second title 168A and a second URL 168B.

In the context of FIG. 1D, the subsystems operate as follows. Content identifier 162 loads content, such as from content sources 118 and stores the content in content storage 164. As discussed, content storage 164 may store a first article 166, associated with a first title 166A and a first URL 166B and a second article 168, associated with a first title 166A and a first URL 166B. Based on the retrieved content, title normalizer 170 normalizes one title or both titles. Aspects of normalization are discussed below. Title comparer 172 compares the normalized titles, and URL comparer 174 compares the URLs. The goal of the comparisons is to establish whether the normalized titles are similar, and if the URLs are similar. However, in one embodiment, if the URLs are the same, de-duplication manager 160 will be able to determine immediately that first article 166 and second article 168 are duplicates.

In one embodiment, image comparer 176 compares first URL 166B with second URL 168B to establish that they identify the same image, and the two URLs 166B, 168B are considered similar if they identify the same image at the same location, but differ only in access aspects, as discussed below.

In another embodiment, image comparer 176 compares the actual images associated with first URL 166B and the image associated with second URL 168B. As discussed below, in such an embodiment, the URLs may be considered similar if they portray the same subject, but differ only in presentation or access aspects. This embodiment considers the URLs similar if the images contain the same content, even if they are at different locations. Additionally, the URLs may be considered similar if the images differ in presentation aspects, as discussed below.

If the two normalized titles and the two URLs are each considered similar to each other, then the articles are determined to be duplicates. Additionally, in one embodiment, if the URLs are the same, de-duplication manager 160 will determine that first article 166 and second article 168 are duplicates even if the titles are not similar.

Otherwise, the articles are determined not to be duplicates. Various further criteria for establishing when normalized titles and URLs are to be considered similar to each other are discussed below.

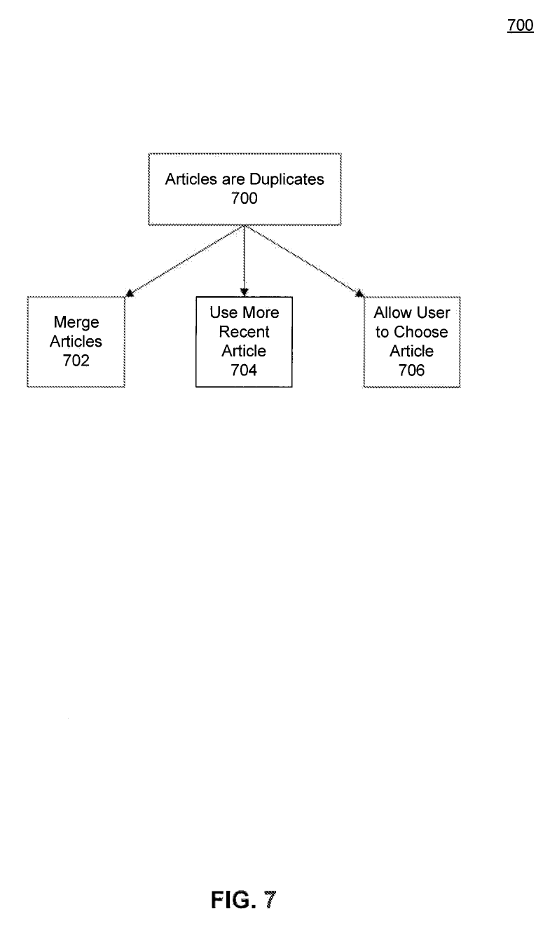

De-duplication manager 160 may then cause further action to be taken based if the articles are determined to be duplicates. Example actions are presented in FIG. 7.

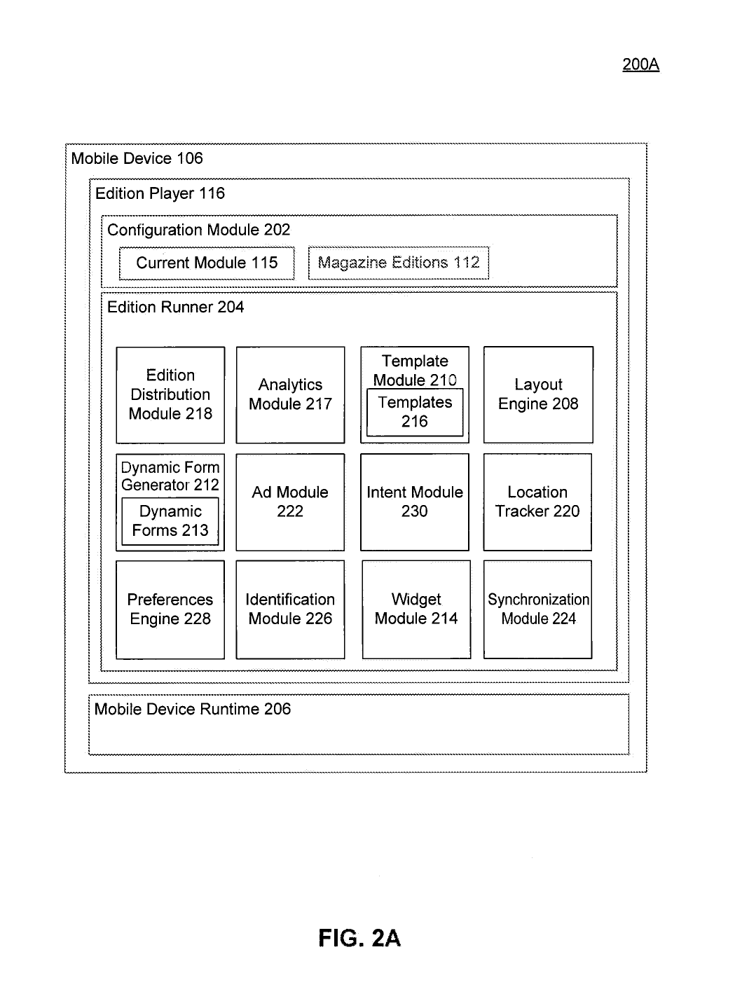

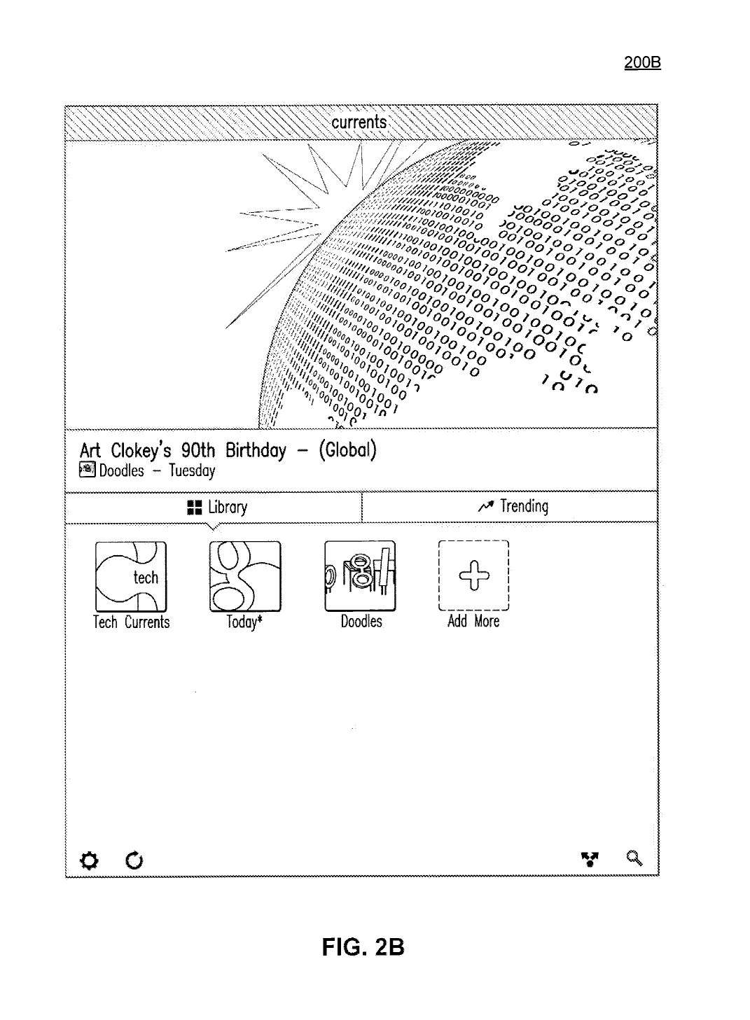

FIG. 2A is a block diagram 200 of an edition player. As described herein, edition player 116 displays magazine editions 112 to a user.

Edition player 116 includes a configuration module 202. Configuration module 202 determines a configuration mode that displays magazine edition 112 on edition player 116. For example, configuration module 202 may be configured to display magazine editions 112 using current module 115, in one embodiment. In another embodiment, configuration module 202 may be configured to display a single instance of magazine editions 112.

Edition runner 204 executes a configuration included in configuration module 202 and displays magazine editions 112. Example configuration may be executing a single instance of magazine edition 112 or executing current module 115 that provides a user with a selection of multiple magazine editions 112.

Edition runner 204 includes a layout engine 208. Layout engine 208 formats media content for display on mobile devices 106 having different specifications. Layout engine 208 receives edition content 132, using, for example, an HTML stream and generates a multi-column layout of edition content 132 that is appropriate for the display screen size and orientation of mobile device 106. Layout engine 208 interacts with template module 210, dynamic form generator 212 and widget module 214.

Template module 210 includes templates 216. Templates 216 control the rendering of the media content in magazine edition 112. Templates 216 may be native templates that are optimized for executing on edition runner 202, as they use the core mobile device runtime 206 libraries. Templates 216 may also be publisher 120 designed templates that display media content in a format designed by publisher 120. When magazine edition 112 is uploaded to mobile device 106, it stores templates 216 in template module 210.

Analytics module 217 tracks magazine editions 112, sections and articles within each magazine edition 112 viewed or read by a user. Analytics module 217 may compile a listing of the read content. The listing may be sent to publisher's 120 analytic account for determining edition content 132 that is interesting to users. The listing may also be sent to the user's account so that edition player 112 may provide a user with a history of edition content 132 that a user has read and/or accessed. Analytics module 217 may also track sections and articles within magazine editions 112 when a user browses magazine editions 112 offline (for example, without access to network 102). Once mobile device 106 is able to access network 102, analytics module 217 uploads the listing to publisher's 120 analytic account and/or user's account.

Edition distribution module 218 communicates with other applications, and distributes magazine editions 112 to third parties. Example third parties may include popular social networking sites, micro-blogging services, email accounts associated with users, etc., to name a few. Edition distribution module 218 may be accessed within magazine edition 112 when a user is reading a particular article or section and causes edition player 116 to distribute the read content.

Location tracker 220 identifies a location, such as latitude and longitude location of mobile device 106. Once the location of mobile devices 106 is identified, edition content 132 included in magazine edition 112 may be tailored to a location of mobile device 106.

Advertisement module 222 inserts advertisements into edition content 132 displayed by magazine edition 112. Advertisement module 222 determines where and when to include advertisements within magazine edition 112. For example, when layout engine 208 renders edition content 132 on a mobile device 106 in a way that includes an unfilled space, advertisement module 222 detects the unfilled space and queries an advertisement system to select an advertisement for inclusion in the unfilled space in real-time. Advertisement module 222 also communicates with various advertising entities that provide advertisement module 222 with advertisements for display within magazine edition 112.

Dynamic form generator 212 generates dynamic forms 213. Dynamic forms 213 render an arbitrary section within magazine edition 112 based on metadata provided by individual users. For example, dynamic forms 213 may be used to display submissions by individual users who, for example, practice citizen journalism.

Synchronization module 224 communicates with a studio backend 126 and retrieves edition content 132 from data storage 128. Synchronization module 224 also identifies the subscriptions that a user subscribed to using particular magazine editions 112 and synchronizes the edition content 132 included in the subscriptions with edition content 132 provided by content sources 118. As discussed previously, de-duplication manager 160 regulates duplicate articles as part of the synchronization process.

Widget module 214 enhances edition content 132 displayed in magazine edition 112. For example, when a slide show is included in edition content 132, widget module 214 renders the slide show. In another example, when edition content 132 includes geo-coordinates, widget module 214 launches an application that displays a map. In another example, when edition content 132 includes a video application, widget module 214 launches a video display application, etc. A person skilled in the art will appreciate that the embodiments above are given by way of example and not limitation and that other means for enhancing edition content 132 may be used.

Identification module 226 identifies a user that uses mobile device 106 and subscribes to particular magazine editions 112.

Preferences engine 228 determines the configuration of a user. For example, a user may configure time intervals for when magazine edition content is synchronized with studio backend 126.

Mobile device runtime 206 executes edition runner 204. Mobile device runtime 206 is a runtime that is native to mobile device 106. Mobile device runtime 206 allows a user to use edition player 116 to view magazine editions 112 on mobile device 106. Typically, mobile device 106 includes different mobile device runtimes 206 that execute mobile device 106 specific operating platforms.

FIG. 2B is an example display view of a current module for displaying multiple magazine editions, according to an embodiment. It provides an example screenshot of several magazine editions that a user may access.

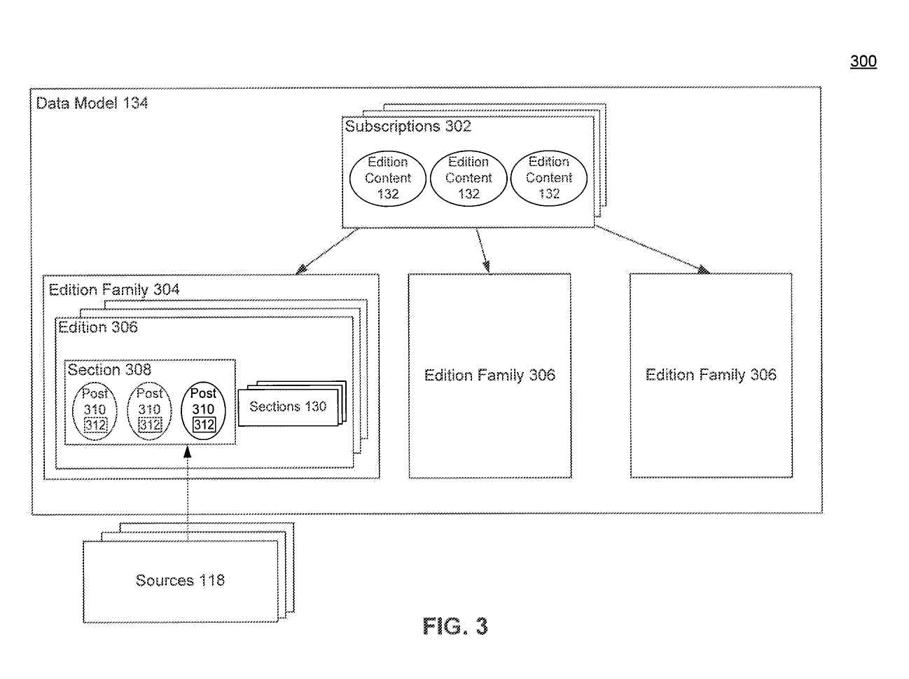

FIG. 3 is a block diagram 300 of a media application data model, according to an embodiment. Application data model 134 is a data model that magazine edition 112 uses to display edition content 132. When publisher 120 builds magazine edition 112 using studio UI 110, it configures edition content 132 into categories within application data model 134.

Application data model 134 includes multiple subscriptions 302. Each subscription 302 is a subscription to content source 118 from which a user subscribes to receive edition content 132 within magazine edition 112. A user may wish to subscribe to his own content source 118 when a user publishes content source 118 or may wish to subscribe to a third party's (e.g. publisher's 120) content source 118.

Magazine edition 112 includes multiple edition families 304 or a single edition 306. Each edition family 304 receives edition content 132 from a particular content source 118. Edition content 132 in each edition family 304 may be distributed among multiple editions 306. Example editions 306 for an edition family 304 may include news content, blog content, video content, etc. Typically, publisher 120 may decide which edition content from source 118 to include in a particular edition 306. Additionally, when publisher 120 designs each edition 306 using studio UI 110, multiple designers associated with a particular publisher 120 may design a particular edition 306 or a set of editions 306 at the same time.

Editions 306 may include multiple sections 308. Sections 308 organize edition content 132 that is provided from content sources 118. For example, edition 306 that includes news content may include a news section and a style section. In another example, edition 306 that includes travel content may include multiple travel sections where each section 308 corresponds to a different region in the world. Each section 308 also includes a table of contents, header, templates 216 for laying out edition content 132 on various mobile devices 106, content source identifiers, etc.

Each section 308 may also include a section type. Section type allows studio UI 110 to optimize the presentation of edition content 132 that is included in section 308 of a particular type. For example, section types may include an RSS feed type, video channel type, social stream type, photo type, products-for-sale type, user-generated articles type that includes citizen journalism, etc.

Each section 308 may have a custom design. In an embodiment, the custom design may be rendered from templates 216 that layout the content of each section 308. As described herein, templates 216 may be native templates provided by studio backend 126 or may be custom templates that are designed for a particular edition 306 or section 308 by publisher 120. In another embodiment, templates 216 may be used to render section 308 on a mobile device 106 that include display screens of different sizes, such as, for example, a tablet and a mobile phone.

Each section 308 includes posts 310. Post 310 represents data associated with a particular unit of content, such as an article, a video, a single image, a “tweet”, a slide show, a map, or any unit of content within content source 118. In an embodiment, post 310 includes multiple items 312. Each item 312 includes information associated with post 310. Example items 312 may include information such as a title, a body, an author, a byline, a media, etc. Depending of what items 312 are included in post 310, post 310 may display a video, an article, a shopping cart item, etc.

Because of the flexibility of application data model 134, a synchronization process of the new edition content 132 received from content sources 118 may be performed on a granularity level of each post 310, and without updating content included in entire edition 306 or section 308.

As discussed above, de-duplication manger 160 will manage duplicate articles so as to eliminate redundancies.

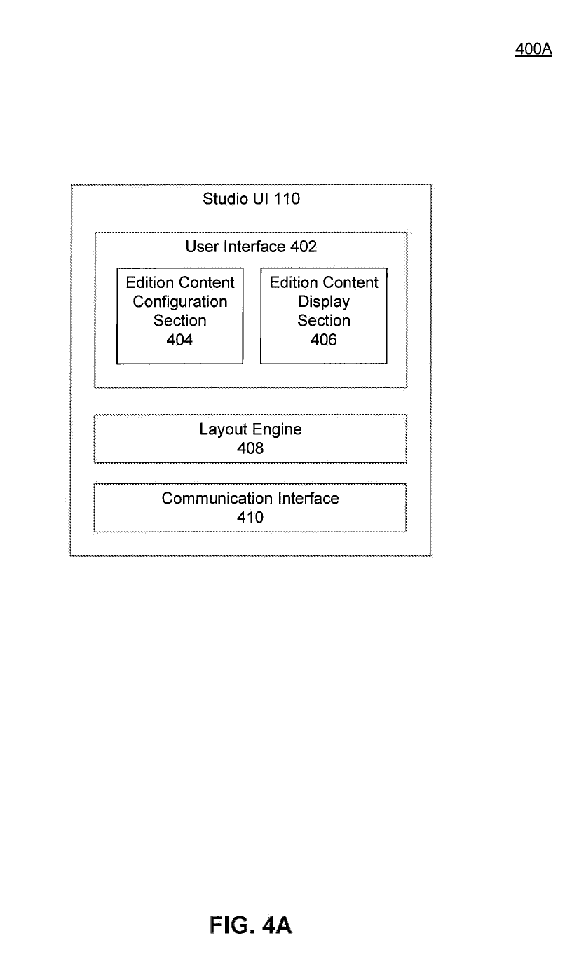

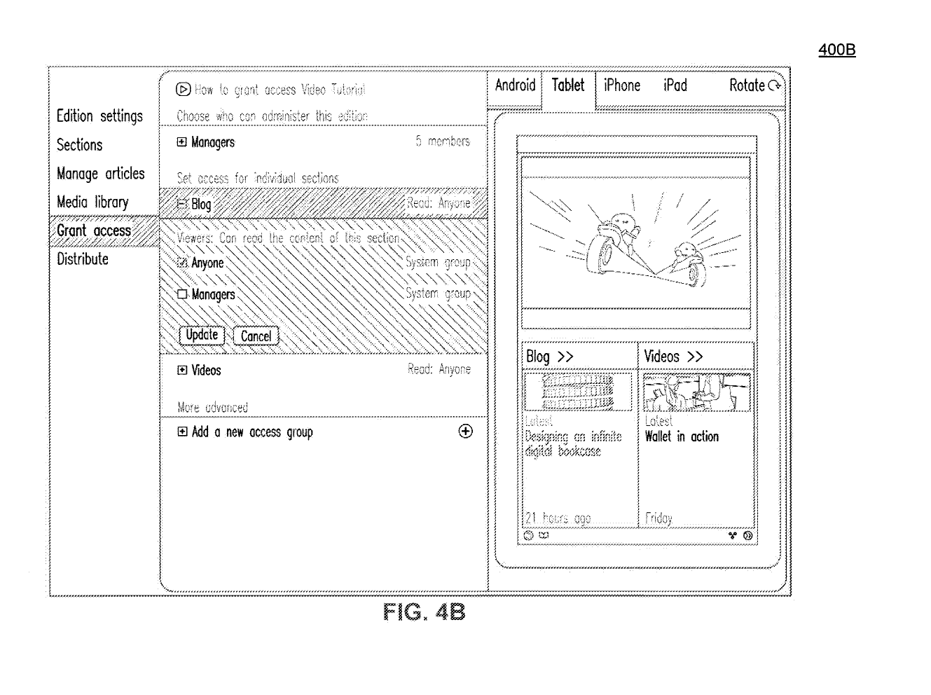

FIG. 4A is a block diagram 400A of a studio architecture, according to an embodiment. Studio UI 110 includes a user interface 402. User interface 402 allows publisher 120 to configure the layout of edition content 132 that is included in magazine edition 112. User interface 402 includes an edition content configuration section 404 and an edition content display section 406. Edition content configuration section 404 allows publisher 120 to select content source 118 that provides edition content 132 for display using magazine edition 112. Edition content configuration section 404 further allows publisher 120 to select multiple sections 308 to display edition content 132. As described herein, example sections 308 may include a news section, a video section, etc. Within each section 308, publisher 120 may further configure content source 118 that provides edition content 132 and template 216 that determines the format in which edition content 132 is displayed on mobile device 106. Edition content configuration section 404 also allows publisher 120 to tailor the display of edition content 132 to a particular mobile device 106.

Edition content configuration section 404 also allows publisher 120 to configure the user population that views edition content 132 provided by magazine edition 112. For example, each section 308 within magazine edition 112 may be configured for viewing by any user, a select group of users, etc.

Edition content configuration section 404 also allows publisher 120 to select advertisers that may provide advertisements to magazine edition 112. For example, when magazine edition 112 displays edition content 132 on mobile device 106, magazine edition 112 may query an advertiser and retrieve advertisements that may be integrated with edition content 132 and be displayed to a user.

Edition content configuration section 404 allows publisher 120 to select merchandise items that may be includes for sale in magazine edition 112. Edition content configuration section 404 also allows publisher 120 to configure a check out interface so that users are able to purchase the merchandise items that are offered for sale.

Edition content configuration section 404 allows publisher 120 to distribute magazine edition 112 to mobile devices 106 or edition distributors 124.

Edition content display section 406 displays edition content 132 from content sources 118 that are included in each magazine edition 112. In an embodiment, edition content display section 406 displays edition content 132 as it may be displayed on various mobile devices 106, such as a tablet or a smart phone. For example, publisher 120 may select to simulate edition content 132 using a particular mobile device 106. Additionally, edition content display section 406 allows publisher 120 to preview the display of edition content 132 using a vertical or horizontal orientation on mobile device 106.

Studio UI 110 also includes a layout engine 408. Layout engine 408 allows publisher 120 to preview edition content 132 as it may be displayed on mobile devices 106 having a particular specification. For example, layout engine 408 determines the size of the display screen of the mobile device 106 that a user selects to preview edition content 132. Layout engine 408 then uses the size of the display screen to format the content in columns as it may be displayed on mobile device 106.

Studio UI 110 includes a communication interface 410. Communication interface 410 receives edition content 132 from data storage 128 for content source 118 that publisher 120 selects for display using magazine edition 112. Publisher 120 may use the received edition content 132 to design sections 308 that display edition content 132 or simulate a layout of edition content 132 on mobile devices 106. In an embodiment, mobile device 106 may also use communication interface 410 to distribute magazine edition 112 when they are ready for distribution.

FIG. 4B is a screen shot of an exemplary embodiment of a studio displaying a user interface. For example, FIG. 4B shows a studio where a magazine edition 112 is being constructed for a tablet. However, it can be readily seen that alternative devices, such as smart phones, may have content tailored for them in the studio.

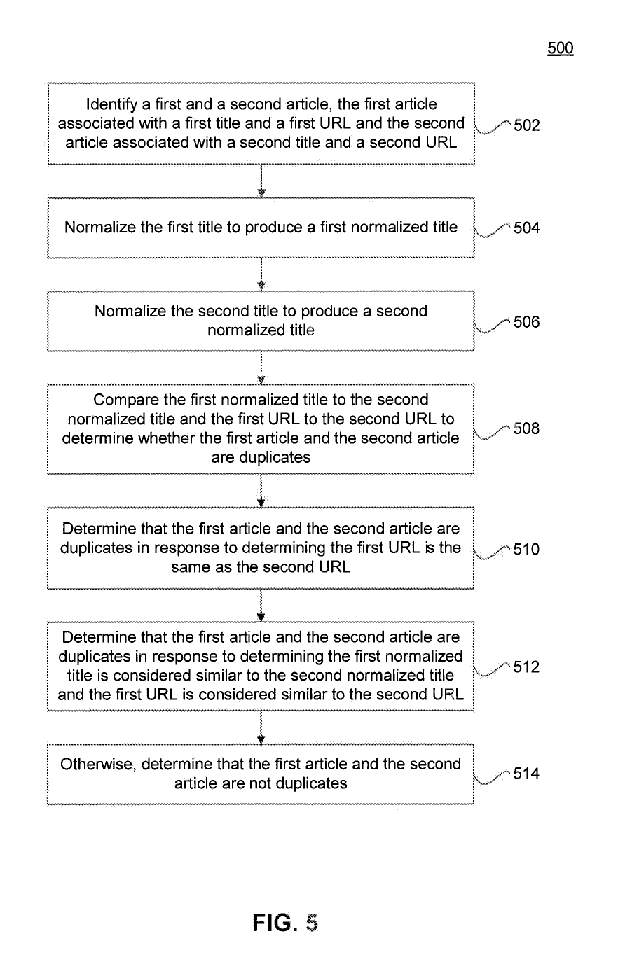

FIG. 5 is a flowchart of a method 500 for managing duplicate articles, according to an embodiment.

At stage 502, a first and a second article are identified, the first article associated with a first title and a first URL and the second article associated with a second title and a second URL. For example, content identifier 162 may identify the articles and their associated titles and URLs in content storage 164. As part of making the articles available, content storage 164 may gather the articles and their associated titles and URLs from data connector 130 and studio backend 126

At stage 504, the first title is normalized to produce a first normalized title. For example, title normalizer 170 may process first title 166A, resulting in a first normalized title. For example, normalizing a title may include one or more of replacing extraneous characters, removing extraneous characters, converting all characters to the same case, correcting spelling, or removing a link associated with the title.

At stage 506, the second title is normalized to produce a second normalized title. For example, title normalizer 170 may process second title 168A, resulting in a second normalized title.

At stage 508, the first normalized title is compared to the second normalized title and the first URL is compared to the second URL to determine whether the first article and the second article are duplicates. For example, title comparer 172 may compare the first normalized title and the second normalized title, and URL comparer 174 may compare the URLs.

At stage 510, it is determined that the first article and the second article are duplicates in response to determining the first URL is the same as the second URL. This determination may be made by URL comparer 174. In general, the reason why this determination is made is that if two articles include exactly the same reference to an image in the article, it is likely that they are in fact the same article and may be considered duplicates. It may be noted that stage 510 is optional, in that not every embodiment will determine that the first article and the second article are duplicates in response to determining the first URL is the same as the second URL. While if the first URL is the same as the second URL, the URLs will always be considered similar, it may be required that the first normalized title and second normalized title are also considered similar for the first article and the second article to be determined to be duplicates, as provided in stage 512.

At stage 512, it is determined that the first article and the second article are duplicates in response to determining the first normalized title is considered similar to the second normalized title and the first URL is considered similar to the second URL. In addition to the operation previously performed by title comparer 172, image comparer 176 uses first URL 166B and second URL 168B to retrieve the images with which they are associated. Based on the retrieved images, first URL 166B and second URL 168B may be considered similar to one another if they point to the same image at the same location, but differ only in access aspects. For example, first URL 166B and second URL 168B may point to the same image at the same location, but one may be a full URL and the other may be a shortened URL, or one may point directly to the image, and the other may point to a location that is subsequently forwarded to the image.

In an alternative embodiment, at stage 512, it may also be determined that the first article and the second article are duplicates when the first normalized title is considered similar to the second normalized title and the content of first image is considered similar to the second image. In addition to the operation previously performed by title comparer 172, image comparer 176 uses the first URL 166B and the second URL 168B to retrieve the images with which they are associated. First URL 166B and second URL 168B are considered similar not only if they point to the same image at the same that differ only in access aspects, as previously discussed. In the alternative embodiment, the images may include the same content at different locations, or may also differ in presentation aspects, as will now be discussed.

For example, presentation aspects might include aspects such as resolution, color depth, and so on. Access aspects might include factors such as whether the URL used to access the image is long or shortened or involves forwarding, as discussed, except that two URLs may point to copies of the same image, but may be judged to have different access aspects if the images are stored at different locations.

However, these aspects are merely examples, and the two images may be considered similar even if they differ in other aspects, so long as the differing aspects affect presentation or access only, and not what is photographed.

For example, a color and a black-and-white photo may present the same subject, or two links may access the same image, even if the links themselves differ. Embodiments can provide varying approaches and degrees of flexibility to comparing images to determine if they should be considered similar. For example, one embodiment may judge a portrait and a close-up of the same person to be considered similar images, but another embodiment may decide that these two images are not considered similar. However, URLs should always be considered similar if they identify the same content at the same location, even if the URLs differ in format.

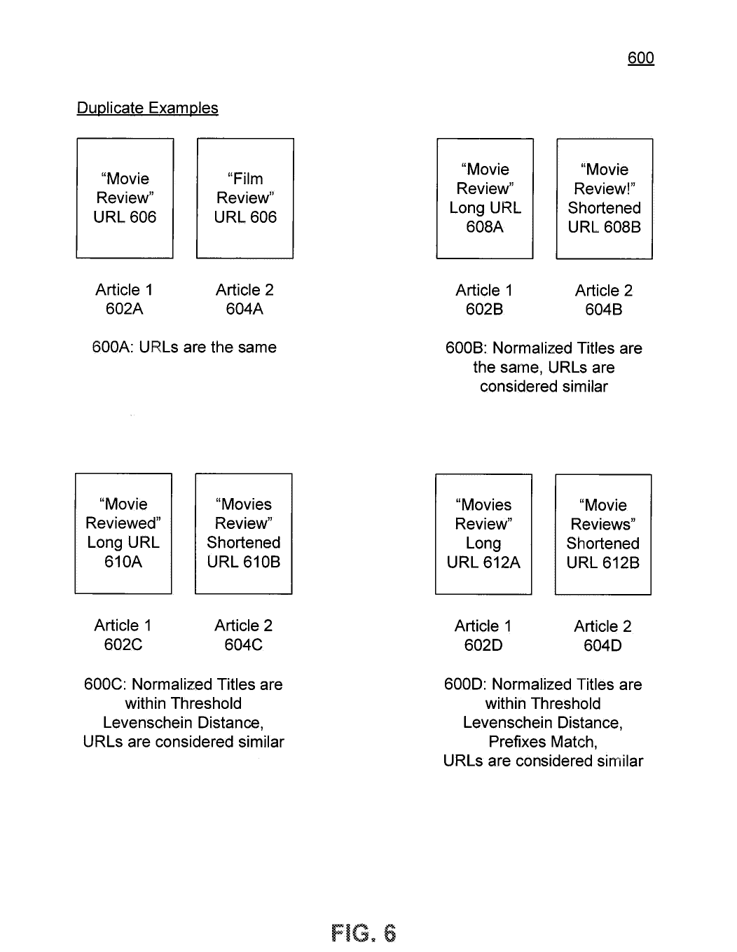

Once it has been established that the two URLs are considered similar, in order for stage 512 to judge that the normalized titles are considered similar, a variety of approaches may be used by title comparer 172. Examples will be provided in the context of FIG. 6.

One approach is that normalized titles may be considered similar if the first normalized title and the second normalized title are the same. It may be noted that the original first title 166A and original second title 168A need not be the same for the normalized titles to be the same. However, if original first title 166A and original second title are, in fact, the same, since the normalization occurs in the same way for each of them, the first normalized title and the second normalized title will necessarily be the same as well. Thus, if first title 166A is “Gold found!” and the second title 168A is “Gold found!!!”, both titles may be normalized to “Gold found” and the articles will be considered to be duplicates if the images are considered similar, as discussed above.

Another approach identifies normalized titles that may be considered similar even if the normalized titles are not exact matches. In this approach, a Levenshtein distance between the first normalized title and the second normalized title is established. A Levenshtein distance is a metric that establishes the minimum number of changes from one string to another. The allowed changes are insertion, deletion, or substitution. For example, the Levenshtein distance from “kitten” to “sitting” is 3, since the changes can be include a first change from “kitten” to “sitten”, a second change from “sitten” to “sittin”, and a third change from “sittin” to “sitting”. The first title and the second title may be considered similar if the first normalized title and the second normalized title have a Levenshtein distance between each other that is less than a predetermined threshold. If the titles are considered similar and the images are considered similar, the articles will be considered to be duplicates.

However, there may be requirements in addition to a Levenshtein distance that is less than a predetermined threshold. For example, the first normalized title and the second normalized title must additionally match a predetermined number of characters as a prefix, a predetermined number of characters as a suffix, or both in order to be considered similar.

It may be noted that these various types of analysis of the normalized titles may be performed by title comparer 172. Levenshtein distances may be implemented by bottom-up dynamic programming, or any other efficient technique. It may be noted that alternative edit distance metrics may be used in lieu of Levenshtein distance in other embodiments. For example, longest common subsequence (allowing only addition and deletion) and Damerau-Levenshtein distance (allowing addition, deletion, substitution and transposition of adjacent characters) may potentially be used as alternative metrics.

At stage 514, otherwise, it is determined that the first article and the second article are not duplicates. For example, de-duplication manager 160 will make this determination if neither stage 510 or 512 was able to determine that the articles were duplicates.

FIG. 6 is a diagram of examples of duplicate articles that an embodiment might identify. FIG. 6 includes duplicate examples 600. Four cases are presented: 600A in which URLs are the same, 600B in which normalized titles are the same and URLs are considered similar, 600C in which normalized titles are within a threshold Levenshtein distance and URLs are considered similar, 600D in which normalized titles are within a threshold Levenshtein distance, prefixes match, and URLs are considered similar.

In case 600A, URLs are the same. The titles differ, in that article 1 602A is entitled “Movie Review” and article 2 604A is entitled “Film Review”. However, both article 1 602A and article 2 604A include the exact same URL 606. Based on the fact that they reference the exact same image at the exact same location, de-duplication manager 160 may consider article 1 602A and article 2 604A to be duplicates, which may be handled as in FIG. 7. However, as previously noted, not every embodiment will consider articles whose URLs are the same, but whose normalized titles are not considered similar, to be situations where the articles are duplicates.

In case 600B, normalized titles are the same and URLs are considered similar. The titles differ, in that article 1 602A is entitled “Movie Review” and article 2 604A is entitled “Movie Review!” However, both of these titles would be normalized to “Movie Review”, since the exclamation point may be considered an extraneous character. Furthermore, both article 1 602A and article 2 604A include similar URLs, such that article 1 602B includes a long URL 608A that contains a full URL that identifies an image, and article 2 604B includes a shortened URL 608B that points to the same image at the same location. Based on the fact that the normalized titles are the same and the URLs point to the same image at the same location, de-duplication manager 160 may consider article 1 602B and article 2 604B to be duplicates, which may be handled as in FIG. 7.

In case 600C, normalized titles are within a threshold Levenshtein distance and the URLs are considered similar. The titles differ, in that article 1 602C is entitled “Movie Reviewed” and article 2 604C is entitled “Movies Review”. Suppose that the titles remain the same after normalization. However, the Levenshtein distance between the titles is 3 (Movies Reviewed, Movie Reviewe, Movie Review, Movies Review). Furthermore, both article 1 602C and article 2 604C include similar URLs, such that article 1 602C includes a long URL 610A that contains a full URL that identifies an image, and article 2 604C includes a shortened URL 610B that points to the same image at the same location. Suppose that the threshold Levenshtein distance is 5. Based on the fact that the normalized titles have a Levenshtein distance that is less than 5 and the URLs point to the same image at the same location, de-duplication manager 160 may consider article 1 602C and article 2 604C to be duplicates, which may be handled as in FIG. 7.

In case 600D, normalized titles are within a threshold Levenshtein distance, prefixes match, and the URLs are considered similar. The titles differ, in that article 1 602D is entitled “Movies Review” and article 2 604D is entitled “Movie Reviews”. Suppose that the titles remain the same after normalization. However, the Levenshtein distance between the titles is 2 (Movies Review, Movie Review, Movie Reviews). Furthermore, the first 5 characters of prefix match, in that both titles begin with the word “Movie”, Alternatives, not show, are that a suffix may need to match, instead of or in addition to the prefix. The important of matching a prefix and/or suffix is that it can help clarify which titles are genuinely similar, in case the titles are so short that the Levenshtein distance alone is not truly indicative of when the titles may be considered similar. Furthermore, both article 1 602D and article 2 604D include similar URLs, such that article 1 602D includes a long URL 612A that contains a full URL that identifies an image, and article 2 604D includes a shortened URL 612B that points to the same image at the same location. Based on the fact that the normalized titles have a Levenshtein distance that is less than 5, the prefixes match (for 5 characters) and the URLs point to the same image at the same location, de-duplication manger 160 may consider article 1 602D and article 2 604D to be duplicates, which may be handled as in FIG. 7.

Thus, as shown in FIG. 6, articles are compared such that their titles and a constituent photo are used as the basis for a determination if they are duplicates. However, it may be recognized that other techniques may be used to make this determination. For example, words in the title may be compared to see if they or synonyms, or additional content such as multiple URLs that may identify multiple photos other media such as videos, audio recordings can serve as the basis for a determination that potentially duplicate articles are, in fact, duplicates.

FIG. 7 is a flowchart of possible actions to take if duplicate articles are identified, according to an embodiment. FIG. 7 begins at stage 700. In stage 700, it is established that the articles are duplicates. FIG. 7 presents three potential responses to discovering duplicate articles.

One response is to merge the articles 702. Merging can occur in a variety of ways. For example, one article may be used as a basis, and the changes between it and the article may be presented as a redline. Alternatively, the merged articles may include shared content only, or shared content plus original content from each article. Clearly, there are many approaches to merging the articles, so an embodiment may allow a user to specify exactly what approach to take when merging the articles.

Another response is to simply use the more recent article 704. While in general the more recent article will be based on the last time the article was edited, it is also possible to make this determination based on the last time a specific user edited the article, the time at which the article was created, and so on.

Finally, one approach is to allow a user to choose the article to use 706. For example, studio UI 110 or edition player 116 may receive a signal from de-duplication manager 160 that it has identified potentially duplicative content. De-duplication manager 160 may interact with user to choose an article to use. Another feature that this approach may encompass is that the user may override the determination from de-duplication manager 160 that the articles are duplicates, and may in fact require de-duplication manager 160 to determine that the articles should be handled as separate articles.

FIG. 8 is an example computer system 800 in which embodiments of the present invention, or portions thereof, may be implemented as computer-readable code. For example, the components or modules of distributed system 100, such as studio UI 110, magazine editions 112, current module 115, studio backend 126, de-duplication manager 160, etc., may be implemented in one or more computer systems 800 using hardware, software, firmware, tangible computer-readable media having instructions stored thereon, or a combination thereof and may be implemented in one or more computer systems or other processing systems. Modules and components in FIGS. 1-7 may be embodied in hardware, software, or any combination thereof.

Mobile device 106, web server 104 and producer server 108 may include one or more computing devices that include a computer system 800. Computer system 800 may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), and application specific integrated circuit (ASIC).

GPU 814 is a specialized processor that executes instructions and programs, selected for complex graphics and mathematical operations, in parallel.

Non-volatile storage 804 may include one or more of a hard disk I've, flash memory, and like devices that may store computer program instructions and data on computer-readable media. One or more of non-volatile storage device 804 may be a removable storage device.

Memory devices 806 may include one or more volatile memory devices such as but not limited to, random access memory. Communication infrastructure 808 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A method for managing duplicate articles, the method comprising:
identifying a first and a second article, the first article associated with a first title and a first URL and the second article associated with a second title and a second URL;
normalizing the first title to produce a first normalized title;
normalizing the second title to produce a second normalized title;
comparing the first normalized title to the second normalized title and the first URL to the second URL to determine whether the first article and the second article are duplicates;
determining that the first article and the second article are duplicates in response to determining the first normalized title is considered similar to the second normalized title and the first URL is considered similar to the second URL; and
otherwise, determining that the first article and the second article are not duplicates.

2. The method of claim 1, further comprising determining that the first article and the second article are duplicates in response to determining the first URL is the same as the second URL.

3. The method of claim 1, wherein normalizing a title includes one or more of replacing extraneous characters, removing extraneous characters, converting all characters to the same case, correcting spelling, and removing a link associated with the title.

4. The method of claim 1, wherein the first URL identifies a first image and the second URL identifies a second image and the first URL is considered similar to the second URL if the two URLs identify the same image at the same location, but differ only in access aspects.

5. The method of claim 4, wherein the first normalized title and the second normalized title are considered similar if the first normalized titles and the second normalized title are the same.

6. The method of claim 4, further comprising establishing a Levenshtein distance between the first normalized title and the second normalized title, wherein the first normalized title and the second normalized are considered similar when the first normalized title and the second normalized title have a Levenshtein distance between each other that is less than a predetermined threshold and the first image is considered similar to the image associated with the second article.

7. The method of claim 6, wherein the first normalized title and the second normalized title must additionally match a predetermined number of characters as a prefix, a predetermined number of characters as a suffix, or both in order to be considered similar.

8. The method of claim 1, further comprising merging together the first article and the second article if they are determined to be duplicates.

9. The method of claim 1, further comprising keeping the more recent one of the first article and the second article and discarding the other if they are determined to be duplicates.

10. The method of claim 1, further comprising enabling a user to choose the first article or the second article to keep and discarding the other if they are determined to be duplicates.

11. A system for managing duplicate articles on an online publication platform, comprising:
a de-duplication manager configured to:
identify a first and a second article, the first article associated with a first title and a first URL and the second article associated with a second title and a second. URL;
normalize the first title to produce a first normalized title;
normalize the second title to produce a second normalized title;
compare the first normalized title to the second normalized title and the first URL to the second URL to determine whether the first article and the second article are duplicates;
determine that the first article and the second article are duplicates in response to determining the first URL is the same as the second URL;
determine that the first article and the second article are duplicates in response to determining the first normalized title is considered similar to the second normalized title and the first URL is considered similar to the second URL; and
otherwise, determine that the first article and the second article are not duplicates.

12. The system of claim 11, wherein the de-duplication manager is further configured to determine that the first article and the second article are duplicates in response to determining the first URL is the same as the second URL.

13. The system of claim 11, wherein the de-duplication manager is further configured to replace extraneous characters, remove extraneous characters, convert all characters to the same case, correct spelling, and remove a link associated with the title.

14. The system of claim 11, wherein the first ULL identifies a first image and the second URL identifies a second image and the first URL is considered similar to the second URL if the two URLs identify the same image at the same location, but differ only in access aspects.

15. The system of claim 14, wherein the first normalized title and the second normalized title are considered similar if the first normalized titles and the second normalized title are the same.

16. The system of claim 14, wherein the de-duplication manager is further configured to establish a Levenshtein distance between the first normalized title and the second normalized title, wherein the first normalized title and the second normalized are considered similar when the first normalized title and the second normalized title have a Levenshtein distance between each other that is less than a predetermined threshold and the first image is considered similar to the image associated with the second article.

17. The system of claim 16, wherein the first normalized title and the second normalized title must additionally match a predetermined number of characters as a prefix, a predetermined number of characters as a suffix, or both in order to be considered similar.

18. The system of claim 11, wherein the de-duplication manager is further configured to:
merge together the first article and the second article if they are determined to be duplicates.

19. The system of claim 11, wherein the de-duplication manager is further configured to:
keep the more recent one of the first article and the second article and discarding the other if they are determined to be duplicates.

20. The system of claim 10, wherein the de-duplication manager is further configured to:
enable a user to choose the first article or the second article to keep and discard the other if they are determined to be duplicates.

21. A computer-readable storage medium having control logic stored therein that, when executed by one or more processors, causes the processors to manage duplicate articles on an online publication platform, the control logic comprising:
a first computer-readable program code to cause the processors to:
identify a first and a second article, the first article associated with a first title and a first URL and the second article associated with a second title and a second URL;
normalize the first title to produce a first normalized title;
normalize the second title to produce a second normalized title;
compare the first normalized title to the second normalized title and the first URL to the second URL to determine whether the first article and the second article are duplicates;
determine that the first article and the second article are duplicates in response to determining the first normalized title is considered similar to the second normalized title and the first URL is considered similar to the second URL; and
otherwise, determine that the first article and the second article are not duplicates.

22. The computer-readable storage medium of claim 21, wherein the first computer-readable program code further causes the processors to determine that the first article and the second article are duplicates in response to determining the first URL is the same as the second URL.
